(19) United States
(12) Patent Application Publication
(10) Pub. No.: US 2017/0186040 A1
(43) Pub. Date: Jun. 29, 2017

(54) INFORMATION PROVISION SYSTEM

(71) Applicant: Shinji NAGASAKA, Okazaki-shi (JP)

(72) Inventor: Shinji NAGASAKA, Okazaki-shi (JP)

(21) Appl. No.: 15/459,694

(22) Filed: Mar. 15, 2017

Related U.S. Application Data
(63) Continuation of application No. PCT/JP2015/074399, filed on Aug. 28, 2015.

(30) Foreign Application Priority Data
Sep. 19, 2014 (JP) 2014-190714

(51) Int. Cl. G06Q 30/02

(52) U.S. Cl. CPC G06Q 30/0267; G06Q 30/0256

(57) ABSTRACT

A display device for playing a video and a management server are connected via a network. In the management server, identification information of a portable terminal used by a user is registered. During playback of the video, the display device establishes short-range communication with the portable terminal in the vicinity thereof, and repeatedly obtains the identification information at a predetermined time interval in order to create a viewing record. The viewing record is transmitted to the management server in appropriate timing. If the portable terminal is in the vicinity of the display device, it can be considered that the user of the portable terminal is likely to be viewing an image displayed on the display device, and thus, the viewing result on the image provided by a plurality of the display devices installed all around the town can be managed by creating the viewing record.

### CLAIM OF PRIORITY

This application is a Continuation of International Patent Application No. PCT/JP2015/074399, filed on Aug. 28, 2015, which claims priority to Japanese Patent Application No. 2014-190714, filed on Sep. 19, 2014, each of which is hereby incorporated by reference.

### BACKGROUND OF THE INVENTION

1. Field of the Invention

The present invention relates to an information provision system for providing advertisements and other types of information via an output device installed in advance.

2. Description of the Related Art

The portable terminals such as a personal computer, a smart phone, a tablet, a mobile phone are widely used for searching and viewing the advertisements and other types of information via the network such as the internet. These types of information are provided not only when a user searches them from the portable terminal but also in a format of an advertisement partially displayed on a web page or the like and but they are provided regardless of intention of the user as automatic delivery from various servers installed on the network to the portable terminals via an e-mail or a social network system in some cases. In a mode in which the information is provided regardless of intention of the user, how to improve results of a user to view the provided information is a problem.

As such a method, Japanese Patent Laid-Open No. 2012-133613 discloses a technology of reading a two-dimensional barcode drawn on a reception slip at a bank or the like and accessing a server in order to deliver videos (motion videos) corresponding to waiting time until a service is provided at that shop. As a result, a probability that the delivered videos are viewed is increased.

Moreover, Japanese Patent Laid-Open No. 2014-086850 discloses a technology of estimating communication capability of a wireless network on the basis of position information of a portable terminal in order to deliver the videos in a format matching the estimated communication capability. As a result, the videos can be viewed smoothly without trouble on the communication capability and a probability of having the videos or the like viewed by a user becomes high.

As described above, various proposals have been made on technologies of delivering various types of information to the portable terminal used by the user.

### SUMMARY OF INVENTION

Recently, display devices of images and speakers for outputting voices are installed anywhere in the towns, and advertisements and other various information are provided from these display devices and speakers in actuality.

However, for output devices for outputting information such as the display devices and the speakers installed in towns, no proposal has been made for improving a probability that users view or listen to the information. Moreover, a method of evaluating how many users have reached this type of information has not been proposed, either. This problem is in common in a case where the information is provided from not only the display devices or speakers installed in the towns but also the output device other than the portable terminal used by the user.

The present invention is made in view of the aforementioned problems and has an object to provide a technology of improving usability of information provision from an output device installed in advance.

One embodiment of the present invention can be configured as an information provision system comprising a portable terminal used by a user, an output device for outputting information, and a management server connected to the portable terminal or the output device via a network, wherein one of the portable terminal and the output device which is connected to the management server is referred to as a first device, and the other is referred to as a second device. The first device includes (a) a detection unit for detecting, within a time period during which the information is being output from the output device, that the second device is in a predetermined positional relationship with respect to the first device such that the user of the second device can be in contact with or receive the information from the output device, (b) an identification information obtaining unit for obtaining identification information specific to the second device from the detected second device, and (c) a contact record storing unit for storing a result of the detection by the detection unit and the obtained identification information as a contact record that the user of the second device had contact with the information. The management server comprises: (d) a contact record database for storing the contact record, and (e) a contact record management unit for obtaining the contact record from the first device via the network and storing it in the contact record database.

Various portable information equipment such as a smart phone, a tablet, a mobile phone, and a laptop computer can be applied as the portable terminal.

As the information provided in the present invention, information with various contents such as advertisement, news, weather forecasts, tourist information, fortune telling, and event information can be used. The information can take various modes such as videos, still images, and voices, and as the output device, a display device such as a display for displaying the information can be used in the case of the videos and still images or a voice playback device and a speaker can be used in the case of a voice output.

These types of information may be stored in the management server or in the output device, or when the output device is connected to the network, they may be stored in any one of the servers on the network.

The network may be a wide range one such as the internet or may be those in a limited region such as an intranet. Communication via the network may be wireless or wired.

Only one of, or both of the portable terminal and the output device may be connected to the network.

According to the information provision system of the present invention, when the second device takes a predetermined positional relationship, the first device detects that fact. The predetermined positional relationship can be defined variously such that the second device is within a predetermined distance from the first device, it is located in a predetermined direction from the first device, it is in a fan-shaped region with a predetermined angle range from the first device and the like.

This predetermined positional relationship is determined as a positional relationship in which the information output from the output device can be contacted, in other words, received by the user in a recognizable manner. For example, when the information is output by displaying the videos or still images, it is a distance or a range where the images can be visually recognized. When the information is output by voice, it is a range where the user can hear the voice.

When the first device and the second device are in the predetermined positional relationship defined as above, it can be estimated that the user of the portable terminal can be in contact with or receive the information output from the output device. Then, when the second device is in the positional relationship as above, the time period during which the user is in contact with the information or the like can be recorded by the first device by obtaining the identification information of the second device.

That is, when the output device is connected to the network as the first device, the output device can record which portable terminal and thus which user contacted the information output thereby, by obtaining the identification information of the portable terminal as the second device. Moreover, when the portable terminal is connected to the network as the first device, the portable terminal can record which output device outputs the information which the user received by obtaining the identification information of the output device as the second device. These records are managed by the management server and can be utilized in various modes such as an analysis of a degree that a specific user is in contact with the information, an analysis of the number of users who the information from a specific output device is transmitted to, and an effort of to motivate various users to contact the information on the basis of these analyses. As a result, the information provision system of the present invention can improve usability of the information output from the output device.

In the information provision system of one embodiment of the present invention, the output device and the portable terminal may comprise a communication device capable of communicating information to each other, respectively, and the identification information obtaining unit may obtain the identification information via the communication device.

As the communication device, a wireless LAN such as WiFi (registered trademark), short-range wireless communication such as Bluetooth (registered trademark), infrared communication and the like can be used.

Even if the communication device is not provided between the output device and the portable terminal, it is not impossible to obtain the identification information by exchanging information via the network. However, according to the aforementioned mode, the identification information can be obtained relatively easily by direct communication between the output device and the portable terminal.

Moreover, whichever the output device or the portable terminal becomes the first device, it may be determined that the partner device is in the predetermined positional relationship on the ground of establishment of the communication by this communication device. However, determination of the positional relationship is not limited to the method above. For example, the first device may obtain the positional information of the second device and determine the positional relationship on the basis of that information. When the communication device with directivity such as the infrared communication is used, it has a merit that, upon establishment of the communication, directions of the first device and the second device can be also reflected naturally in determination of the positional relationship.

In one embodiment of the present invention, the detecting unit may intermittently make detection within the period during which the information is output from the output device.

By configuring as above, the period of contacting the information can be specified with a relatively light load. That is, in order to specify to what degree the user contacted the information output from the output device, a point of time when the contact is started and a point of time when it is ended need to be specified. However, in order to strictly specify these points of time, the positional relationship between the output device and the portable terminal needs to be detected at all times, and its load is not ignorable. On the other hand, in the aforementioned mode, since the detection is made intermittently, the start and end points of time can be specified with a light load.

In this mode, an interval of the detection can be set arbitrarily in relation with detection accuracy. When the interval is made larger, the detection load is reduced, but specification accuracy of the points of time of start and end of the contact with the information is lowered. On the other hand, if the interval is made smaller, the specification accuracy is improved, but the load is increased. The detection interval may be set by considering the both.

The aforementioned mode has higher usability when the communication device is provided between the output device and the portable terminal, and a method of determining that the both are in the predetermined positional relationship upon establishment of the communication by the communication device is employed. When the communication is established, it can be determined as a point of time when the contact with the information is started, and by intermittently checking establishment of the communication and by determining that a point of time when the communication is discontinued is a point of time when the contact with the information is ended, start and end of the contact can be specified relatively easily.

In one embodiment of the present invention, the output device may start output of the information using detection of the portable terminal or detection by the portable terminal as a trigger.

That is, this is a mode that the output of the information is started when the output device and the portable terminal come to be in the predetermined positional relationship. As a result, unnecessary information provision by the output device can be suppressed.

Processing when a new portable terminal is detected during the output of the information can be in various modes. For example, the detection of a new portable terminal may be ignored. If new portable terminals are continuously detected, the subsequent information provision may be started immediately at a point of time when the output information provision is finished.

Moreover, in such a mode, the information from the output device can be obtained only by the user of the information provision system of the present invention or those close to the user. Even if how many of those other than the user of the information provision system of the present invention are present closer to the output device, the aforementioned detection is not made and thus, the information is not output. Therefore, the aforementioned mode can exert an effect of increasing a desire of people to receive the information presentation from the output device and motivating them to use the information provision system of the present invention.

Furthermore, the aforementioned mode is particularly useful when videos are output. The users have a desire to view the information by the videos not from the middle but from the beginning. According to the aforementioned mode, in response to such a desire, the output of the videos can be started when the output device and the portable terminal come to be in the predetermined positional relationship and the user is determined to be at a position in which the user can contact the information and thus, it has a merit that the user can view the videos from the beginning.

In one embodiment of the present invention, the output device may be connected to the network, and may comprise an information obtaining unit for obtaining information data for outputting the information via the network, and an information recording unit for recording the obtained information data, wherein the information obtaining unit obtains the information data when at least one of the following conditions is satisfied: (ii) there is no information data which has not been outputted in the information storage unit; and (ii) there is no information data within a viewing period thereof, i.e., there is no information data whose predetermined viewing period has not expired.

For example, while un-output information data is present in the information data obtained by the information storage unit, new information can be provided to the user by using the non-played-back information data without obtaining new information data. On the other hand, when there is no un-output information data, new information data is preferably obtained in order to avoid distraction of the user.

Also, there is some information data whose contents have meanings only in a limited period of time such as weather forecasts, fortune telling, and event information. For such information data with a limited viewing period, it is preferable that the information data is deleted and the new information data is obtained when the viewing period expires.

According to the configuration above, since the information data is obtained by considering these conditions, the information can be provided efficiently with suppressing distraction of the user. Both of, or any one of the aforementioned two conditions may be considered. Moreover, this mode can be similarly applied when the information data storable in the information storage unit is of one piece or of plural pieces.

As a method of providing the new information to the user, there can be a method of obtaining information data in a relatively short cycle whether the user has viewed it or not, but there is a concern that the information data is obtained excessively. On the other hand, according to the configuration above, there is a merit that the new information can be provided to the user while such excessive obtainment is suppressed.

Note that the timing for obtaining the information data in the present invention can be configured variously regardless of this mode. For example, the information data may be obtained periodically or may be obtained at timing when a predetermined number of pieces of the information data stored in the video storage unit have been viewed.

In one embodiment of the present invention, the contact record management unit may comprise a privilege management unit for determining a privilege given to the user of the portable terminal.

According to the aforementioned mode, giving the privilege to the user motivates the user and a probability that the user contacts the information can be further increased.

The privileges can include a discount or exemption of a usage fee of the portable terminal, and provision of coupons or points which can be used in various online shops, actual shops and the like. Privileges with uniform contents may be given when a predetermined number or predetermined time of the contact with the information by the user is exceeded, or the contents of the privileges may be changed in accordance with the number or time of the contact with information, for example. Moreover, the contents of the privileges may be determined by changing an evaluation value in accordance with a type of the information such as videos, still images, and voice.

In the case of the configuration including the privilege management unit, at least one of the first device and the management server may compensate missing of the detection within the predetermined period in the detection results in order to specify a time period during which the user is in contact with the information and determine the privilege.

The information provision system of the present invention determines that the user is in contact with the information when the first device and the second device are in the predetermined positional relationship and takes a contact record, but a period during which the positional relationship of the second device cannot be temporarily detected due to an influence of defective communication, a noise or the like, that is, missing of the detection can occur. Although such missing of the detection can be handled as indicating that the user is not in contact with the information, but considering a possibility of occurrence of the defective communication as above, it is not necessarily an appropriate processing.

In the aforementioned mode, since a contact record can be created by compensating the missing of the detection within the predetermined period, that is, by regarding that the missing of the detection did not occur, the influence of the defective communication, a noise or the like can be suppressed, and the contact record can be obtained.

The “predetermined period” which is a standard to determine whether the missing of the detection should be compensated or not can be configured arbitrarily. For example, it may be configured as an average value, a maximum value or the like of the period during which the missing of the detection occurs on the basis of statistic data on the missing in the detection of the second device. The “predetermined period” does not have to be a fixed value, but may be changed by learning a result of the missing in each time when the missing occurred, or may be changed in accordance with a period of time in a day or a place.

In one embodiment of the present invention, there is no need to include all the aforementioned various features but some of them can be omitted or combined as appropriate in configuration.

The present invention can be configured in various modes regardless of the mode as the aforementioned information provision system. For example, the present invention may be configured as an output device used in the aforementioned information provision system.

Such configuration may be, for example, an output device connected to the management server in the information provision system via the network, for outputting the information. The output device may comprise (a) a detecting unit that detects, within a time period during which the information is output, that the portable terminal used by the user of the information provision system is in a predetermined positional relationship with respect to the output device, (b) an identification information obtaining unit that obtains identification information specific to the portable terminal from the detected portable terminal, (c) a contact record storing unit for storing a result of the detection by the detecting unit and the obtained identification information as a contact record that the user of the portable terminal is in contact with the information, and (d) a contact record reporting unit for reporting the contact record to the management server.

Such an output device can detect the portable terminal and create the contact record. Various features described above with respect to the information provision system can also be reflected to this output device.

Moreover, the present invention may be configured as a contact record managing method for managing a record that a user was in contact with the information by a management server in the aforementioned information provision system. Furthermore, the present invention may be configured as a computer program for realizing the aforementioned respective functions in the portable terminal, output device, and management server or as a computer-readable recording medium which records the computer program.

### BRIEF DESCRIPTION OF THE DRAWINGS

FIG. 1 is an explanatory diagram illustrating entire configuration of an information provision system.

FIG. 2 is an explanatory diagram illustrating internal configuration of the information provision system.

FIG. 3 is an explanatory diagram illustrating a configuration of each database.

FIG. 4 is a flowchart of image display processing.

FIG. 5 is a flowchart of viewing record storing processing.

FIG. 6 is a flowchart of video management processing.

FIG. 7 is a flowchart of viewing result tabulation processing.

FIG. 8 is an explanatory diagram illustrating an overall configuration of the information provision system in Embodiment 2.

FIG. 9 is an explanatory diagram illustrating an internal configuration of the information provision system in Embodiment 2.

FIG. 10 is a flowchart of viewing history recording processing.

### DESCRIPTION OF EMBODIMENTS OF THE INVENTION

### Embodiment 1

### A. System Configuration:

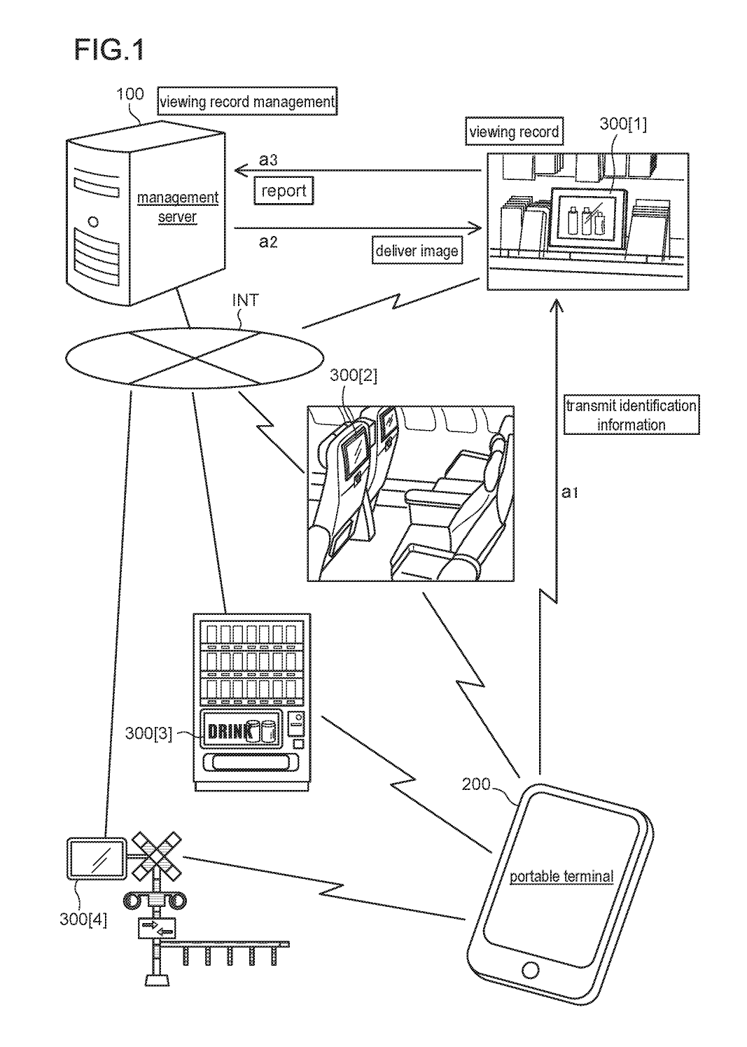

FIG. 1 is an explanatory diagram illustrating entire configuration of an information provision system. The information provision system is a system for displaying images delivered from a management server 100 on a display device 300 (numerals [1] to [4] are given to specific installation examples in the figure) and records, by using a portable terminal 200, a history that a user viewed the displayed information. While a system providing information by displaying videos is described as an example in this embodiment, the information provision system may be also configured as a system providing voice information. Moreover, the information provision system may be configured to select as appropriate and provide a plurality of types of sources such as still images, videos, and voices. As the provided information, advertisements, news, weather forecasts, tourist information, fortune telling, event information and the like can be considered.

The management server 100 and the display device 300 are connected via an internet INT. In this embodiment, the display device 300 corresponds to a first device in the present invention.

Devices which can be used as the display device 300 are exemplified in the figure. The display device 300[1] is a digital signage for introducing goods installed in a shop and displays various advertisements and the like. The display device 300[2] is a display installed at a seat of an aircraft and the like and displays information relating to onboard security, tourist information at a destination, weather, and entertainment such as movies. The display device 300[3] is a display attached to a vending machine and displays various advertisements. The display device 300[4] is a display attached to a railroad crossing and displays service states of trains, advertisements and the like. As the display device 300, various devices other than those exemplified here can be used. Moreover, the device is not necessarily limited to a display installed in a public place but may be a display attached to a refrigerator and other home electric appliances.

As the portable terminal 200, various types of portable information equipment such as a smart phone, a tablet, a mobile phone, and a laptop computer can be applied. In this embodiment, the portable terminal 200 corresponds to a second device in the present invention.

In this embodiment, a short-range communication device is provided between the portable terminal 200 and the display device 300. As the short-range communication device, WiFi (registered trademark), Bluetooth (registered trademark), infrared communication and the like can be used, for example. When the portable terminal 200 is connectable to the internet INT, the short-range communication device may be omitted.

The management server 100 also manages a result that the user viewed the information provided on the display device 300, and can give privilege such as a discount or exemption of a usage fee or the like in accordance with the result. The result of viewing by the user is managed via the portable terminal 200. A management method of the result of viewing will be described in a flow of information described below.

In the figure, the flow of the information exchanged in the information provision system is illustrated.

When the portable terminal 200 approaches the vicinity of the display device 300[1], the short-range communication is established between the both. For example, such a method of establishing communication can be employed that the display device 300[1] sends a beacon for establishing communication, and the portable terminal 200 detects the beacon and replies to it. When the communication is established, the portable terminal 200 transmits its own identification information to the display device [1] (arrow a1). The display device 300[1] obtains the identification information so as to detect that the portable terminal 200 is in such a positional relationship that the short-range communication can be established.

For example, various types of information associated with each user including a terminal ID specific to the portable terminal 200, a user ID given to the user using the portable terminal 200 for using the information provision system in the embodiment and the like can be used as the identification information.

To the display device 300[1], an image delivery, that is, video data for display is delivered from the management server 100 (arrow a2). This video data may be delivered at display or may have been delivered in advance. Moreover, information indicating location of the video data such as an URL may be delivered from the management server 100, or the display device 300[1] may obtain the video data via the internet INT.

The display device 300[1] displays the delivered image. Moreover, while displaying the image, it intermittently obtains the identification information of the portable terminal 200 at predetermined timing and stores it as a viewing record. The number of the portable terminals 200 detected by the display device 300[1] is not limited to one. The display device 300[1] obtains the identification information corresponding to the respective portable terminals 200 and creates the viewing records corresponding to a plurality of the portable terminals 200.

This viewing record is transmitted to the management server 100 at appropriate timing. The management server 100 manages the viewing record and utilizes it for privileges such as a discount of a usage fee of the portable terminal 200.

Similar exchange of the information is performed in the display devices 300[2] to 300[4]. That is, each of the display devices 300[2] to 300[4] displays images, respectively, creates a viewing record on the basis of the identification information of the portable terminal 200 close to itself and reports it to the management server 100.

When the portable terminal 200 is in the vicinity of the display device 300, the information provision system of this embodiment determines that it is likely that the user of the portable terminal 200 watches the image displayed on the display device 300 and creates a viewing record. As a result, even though the user does not operate the portable terminal 200, the viewing record is created automatically and is reflected to the privilege. When the results of viewing the images increase, the privilege such as a discount of the usage fee of the portable terminal can be given, and thus, remaining in the vicinity of the display device 300 is beneficial also for the user. If the user stays in the vicinity of the display device 300, a probability of viewing the displayed image is naturally increased and thus, the information provision system can generally increase the probability that many users view the image displayed on the display device 300.

Moreover, from a viewpoint of a business entity or the like providing the video data, by means of creation of the viewing record, information on how many users are viewing the displayed image at which period of time in a day and the like can be obtained. As a result, it is possible to improve contents of the images to be displayed so that more users view them, and the like.

An operator of the information provision system can gain profits by obtaining a usage fee from a business entity or the like for using the system, even if a privilege of a discount of a usage fee of the portable terminal is given to the user.

In this embodiment, it is determined that the portable terminal 200 is located in the vicinity by establishment of the short-range communication between the portable terminal 200 and the display device 300, but the positional relationship of the portable terminal 200 may be evaluated in more detail. For example, the direction of the portable terminal 200 with respect to the display device 300 may be determined on the basis of the positional information obtained from the portable terminal 200. As a result, when the portable terminal 200 is located on a rear surface side (side where the image is not displayed) of the display device 300, it can be determined that the information cannot be viewed.

Also, a communication device with directivity such as infrared communication may be used as means for short-range communication. Then, since the communication is established when the portable terminal 200 is in a predetermined direction of the display device 300, directions of the both can be naturally reflected to the determination of the positional relationship.

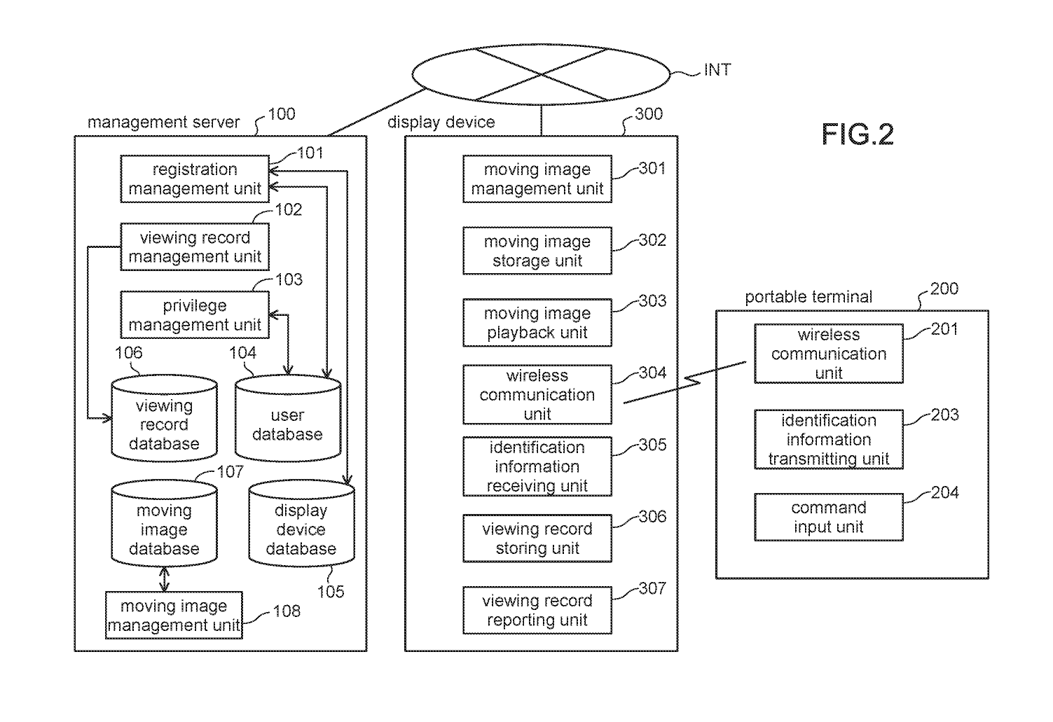

FIG. 2 is an explanatory diagram illustrating internal configuration of the information provision system. Functional blocks which should be included in each device in order to realize the function explained in FIG. 1 are illustrated. In this embodiment, the management server 100, the portable terminal 200, and the display device 300 are all computers each including a CPU, a RAM, a ROM and the like and thus, each of the functional blocks is assumed to be configured in a software manner by installing computer programs for realizing the respective functions mainly in the computers but any one of them can be also configured in a hardware manner.

Configuration of the management server 100 will be described.

The management server 100 includes four databases, that is, a user database 104, a display device database 105, a video database 107, and a viewing record database 106. The user database 104 relates to a user using the information provision system, and stores basic information such as a name, a terminal ID of the portable terminal in use and the like. The display device database 105 stores basic information such as identification information attached to the display device 300. The video database 107 stores the video data to be delivered to the display device 300 or its link information and the like. This embodiment is configured capable of storing the both in a mixed manner. The viewing record database 106 obtains and stores together the viewing records recorded by each of the display devices 300.

A video management unit 108 manages the video database 107. It receives an upload of the video data, link information and the like from the server storing the video data (not shown,) and stores them in the video database 107. Moreover, it delivers the video data in response to a request from the display device 300. The video may be delivered simply from the older ones stored in the video database 107 or those matching attributes specified by each of the display devices 300 or the like may be delivered with priority.

A registration management unit 101 manages registration of information in the user database 104 and the display device database 105.

A viewing record management unit 102 exerts a function of obtaining a viewing record from each of the display devices 300 and updates a viewing record database 106 on the basis of that.

A privilege management unit 103 exerts a function of determining a privilege to the user on the basis of the viewing history. Contents of the privileges can include provision of a complimentary coupon which can be used in various online shops and the like, reduction of the usage fee of the portable terminal 200 and the like. When the information is provided by using a plurality of types of sources such as a video, a still image, a voice and the like, the viewing history may be converted to common points by a predetermined evaluation method in accordance with the type of the source and the privilege may be determined in accordance with the points. The viewing history is individually managed for each type of the sources so that the privileges are classified according to the type and determined.

Configuration of the display device 300 will be described.

A video management unit 301 obtains video data for playback from the management server 100. The obtained video data is stored in a video storage unit 302. Although the video storage unit 302 may store only one piece of the video data, the video storage unit 302 in this embodiment is configured to be capable of storing plural pieces of the video data.

A video playback unit 303 plays back a video by using the video data stored in the video storage unit 302. In this embodiment, the videos are played back when it is detected that the portable terminal 200 is located in the vicinity.

A wireless communication unit 304 exerts a function of establishing the short-range communication with the portable terminal 200. Although Bluetooth (registered trademark) is used in this embodiment, other short-range communication may be used. Since the presence of the portable terminal 200 can be detected by establishment of the communication, the wireless communication unit 304 exerts the function as a detecting unit of the first device in the present invention.

An identification information receiving unit 305 obtains the identification information from the portable terminal 200 via the short-range communication.

A viewing record storing unit 306 records the identification information of the portable terminal 200 located in the vicinity in a time series while the videos are displayed. As a result, a viewing record associated with the type and time of the videos on display and a user estimated to view them can be created.

A viewing record reporting unit 307 reports the viewing record to the management server 100 at appropriate timing. The timing for reporting and the like can be configured arbitrarily. For example, a method of uploading to the management server 100 periodically, a method of uploading in accordance with a command from the management server 100, a method of uploading when a capacity of the viewing records stored in the display device 300 reaches a predetermined amount or more and the like can be employed.

Configuration of the portable terminal 200 will be described. A terminal ID for identifying the portable terminal is given to the portable terminal 200. A command input unit 204 inputs a command by an operation by the user via a screen of the portable terminal 200 or various physical switches and the like. A wireless communication unit 201 exerts a function of establishing the short-range communication with the display device 300.

An identification information transmitting unit 203 transmits the identification information of the portable terminal 200 to the display device 300 via the short-range communication with the display device 300. Although the identification information is transmitted via the short-range communication in this embodiment, a method of obtaining the identification information from the management server 100 via the internet INT may be employed. For example, the display device 300 initially outputs a search request to the management server 100 on whether or not the portable terminal 200 is in the vicinity. In response to this, the management server 100 obtains the positional information of each of the portable terminals 200, extracts the portable terminal 200 in the vicinity of the display device 300, and transmits the identification information corresponding to that to the display device 300. The identification information can be also obtained by this method.

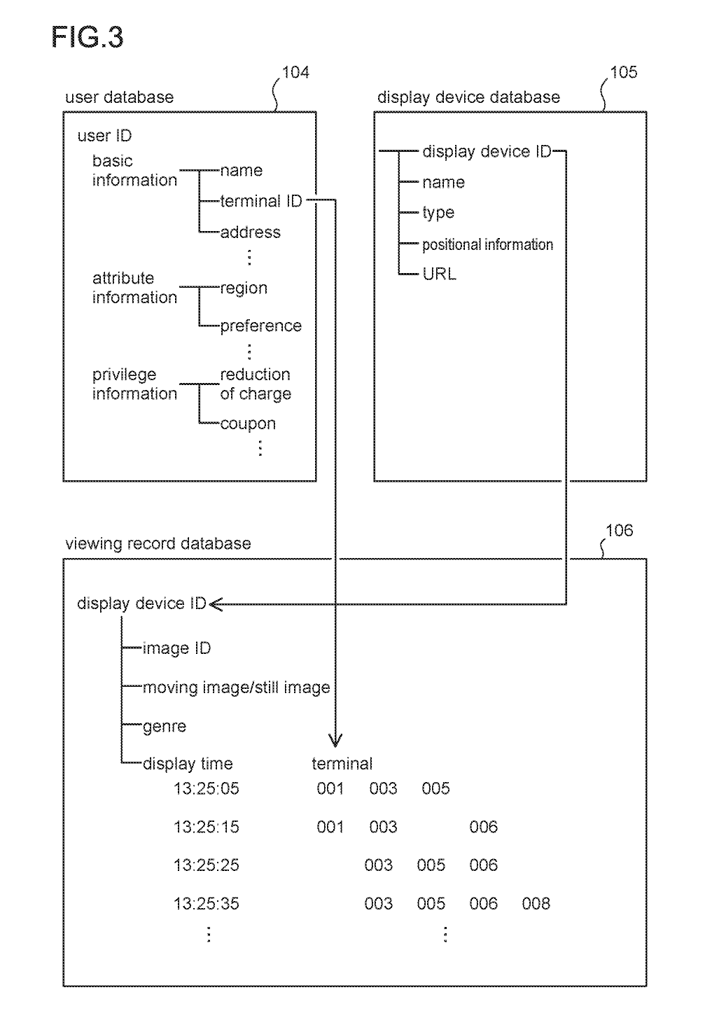

FIG. 3 is an explanatory diagram illustrating configuration of each database. The configurations of the user database 104 and the display device database 105 are illustrated on an upper side, while the configuration of the viewing record database 106 is illustrated on a lower side.

The user database 104 stores the basic information, attribute information, privilege information and the like in addition to the user ID for identifying each of the users. The basic information is personal information of the user such as a name, a terminal ID, an address and the like.

As the attribute information, information such as a region, a preference registered by the user is stored. This information is used for, for example, displaying the video according to the preference of the user and the like.

The privilege information stores privileges given to the user on the basis of the viewing history. Contents of the privileges include reduction of charges to the portable terminal 200, or provision of coupons and the like.

The display device database 105 stores information of the various display devices 300 illustrated in FIG. 1. The stored information includes a display device ID specific to the display device 300, a name, a type, positional information, an URL and the like. The type is information indicating where the display device is installed such as a digital signage at a shop (the display device 300[1] in FIG. 1), and a seat of an aircraft and the like (the display device 300[2] in FIG. 1). The positional information indicates a position where the display device 300 is installed. In the case of the display device installed in a moving body such as a seat of an aircraft (the display device 300[2] in FIG. 1 or the like), the positional information may be omitted or a flag or the like indicating that the display device is installed in a moving body may be stored. The URL is information indicating a location of the display device 300 on the internet ITN in order for the management server 100 to exchange information with the display device 300.

The viewing record database 106 stores viewing records obtained from each of the display devices. The viewing record is configured by information such as an image ID, a type of video/still image, a genre, display time, and a terminal in correspondence to the display device ID of the display device 300 which created the viewing record. The display device ID corresponds to the identification information stored in the display device database 105.

The image ID is identification information for identifying a displayed image. The video/still image is information indicating a type of the image. Although all the cases illustrated in this embodiment are those displaying the videos, this information can be utilized when the videos and still images are used at the same time.

The genre is a type such as sports and gourmet given in accordance with the contents of the video.

The information of the display time and the terminal are stored as time when the video is displayed and the identification information of the portable terminal 200 detected at that time in association with each other. In this embodiment, this information is intermittently recorded at an interval of 10 seconds during display of the video. The timing for recording the information is not limited to 10 seconds but can be configured arbitrarily.

The example in the figure indicates that three portable terminals 200 with the terminal IDs 001, 003, and 005 are in the vicinity at a point of time “13:25:05”. Hereinafter, at each time illustrated similarly, the portable terminals 200 with each of the terminal IDs are in the vicinity. From this record, it can be found that the portable terminal 200 with the terminal ID (001) was in the vicinity of the display device 300 for 20 seconds from 13:25:05 to 13:25:25 when the identification information is no longer obtained. Similarly, the time when the portable terminal 200 with the terminal ID (003) was in the vicinity is specified as 13:25:05 to 13:25:35 and after.

Here, regarding the terminal ID (005), data is missing at the time 13:25:15 during the time 13:25:05 to 13:25:35. In such a case, it can be processed by considering that the terminal ID (005) is not in the vicinity at the time when the data is missing, but in this embodiment, if the data missing is for a relatively short time, the missing is compensated. Specifically, if the data missing is within 30 seconds, the missing is determined to be due to nonconformity of communication or an influence of a noise and the like, and a period when the data is missing is also handled assuming that the terminal is in the vicinity of the display device. As a result, a staying time is obtained assuming that the terminal ID (005) is continuously in the vicinity of the display device at time 13:25:05 to 13:25:35 and after. By configuring as above, calculation of a staying time or the like acting disadvantageously for the user due to an influence of a noise and the like can be avoided.

By means of the system configuration as above, the information provision system realizes the various functions described in FIG. 1. Processing contents for realizing the respective functions will be described below on the basis of flowcharts.

### B. Image Display Processing:

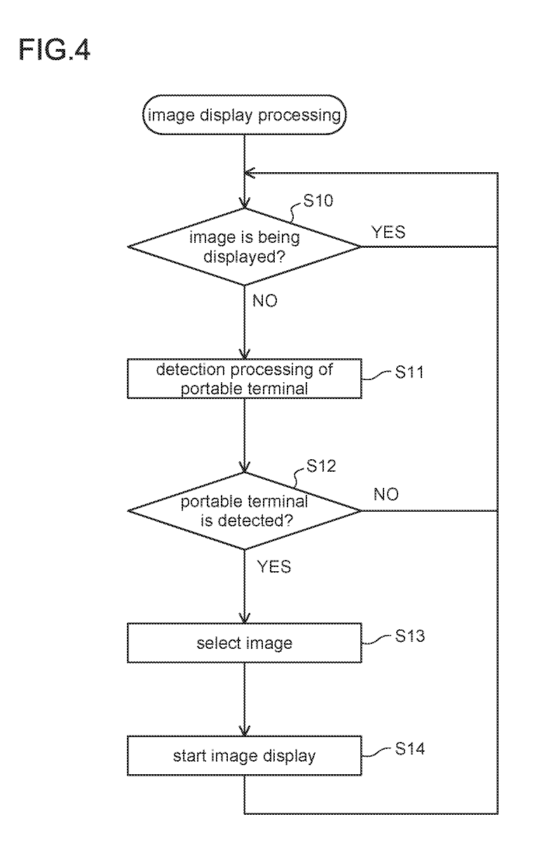

FIG. 4 is a flowchart of image display processing. This is the processing executed by the display device 300.

When this processing is started, if the display device 300 has been already displaying an image (Step S10), it continues the display.

If the image is not being displayed (Step S10), detection processing of the portable terminal 200 is executed (Step S11). It is the processing of outputting a beacon from the display device 300 and detecting whether the portable terminal 200 responds to the beacon or not. This processing can be intermittently executed in parallel with other processing while the display device 300 is in operation regardless of whether the image is being displayed or not.

When the portable terminal 200 cannot be detected (Step S12), processing at Steps S10 and S11, that is, detection of the portable terminal 200 is repeatedly performed.

When the portable terminal 200 is detected, the display device 300 selects the video to be played back (Step S313). The video may be simply selected from those with older timing of being stored in the video storage unit 302 or may be selected at random, but in this embodiment, the selection is made on the basis of the following three preference conditions:

The first condition is a video which has not been played back. Many users view the display device, and since a video that has not been played back is likely not to have been viewed by the users, a probability that users view that video is increased.

The second condition is “those with an earlier expiration date (time) for the playback period”. In some of the videos such as the weather forecast, fortune telling, advertisements of an event or a campaign with limited time and date and the like, meaning of the information is substantially lost after expiration of the certain playback period. By playing back the video with the earlier expiration date of the playback period with priority, discarding of these videos without having been played back can be avoided.

The third condition is a preference of the user. By playing back the video relating to sports in preference to the user who likes sports, the user's interest can be attracted, for example. The preference of the user can be specified by transmitting the identification information of the detected portable terminal 200 to the management server 100 and receiving a reply on the preference or the like recorded in the user database 104 from the management server 100.

By selecting the video on the basis of the conditions 1 to 3 as above, information which does not tire the user but is meaningful and interesting can be provided to the user of the detected portable terminal 200.

There is no need to consider all the conditions 1 to 3 for selecting the video, but some of them may be omitted. Moreover, conditions other than them may be added. If playback time differs among the videos, for example, a length of the playback time can be also considered as a condition for selecting the video.

When the video is selected, the display device 300 starts display of the selected image (Step S14). By repeatedly executing the aforementioned processing, the display device 300 can display the video.

Although the detection processing of the other portable terminals 200 is not executed (Step S11) during display of the image in the processing example in FIG. 4, but it may be executed in parallel. By configuring as above, such a mode can be embodied that the user newly approaching the vicinity of the display device during the display of the image can be detected and after the playback of the image in display is finished, an image matching the preference of the second user who is approaching is displayed and the like.

### C. Viewing Record Storing Processing

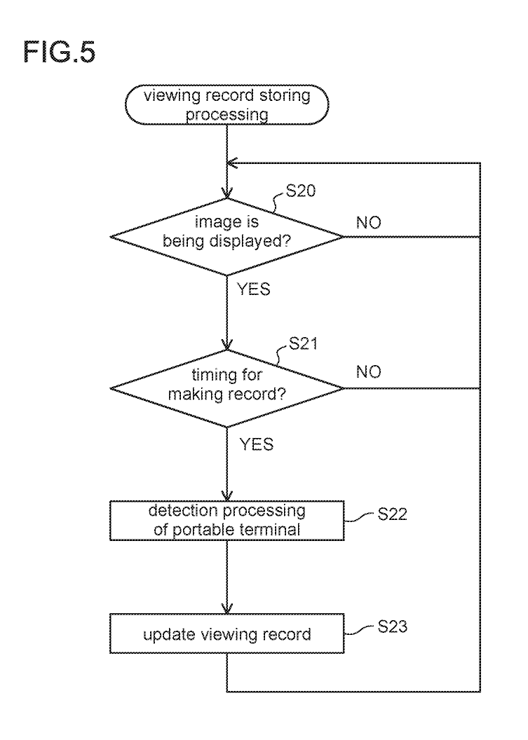

FIG. 5 is a flowchart of viewing record storing processing. This is the processing that the display device 300 sequentially records the information of the portable terminal 200 in the vicinity and creates the viewing record during display of the image.

When the processing is started, if the image is not being displayed (Step S20), the display device 300 does not do anything but repeats the processing from the beginning.

When the image is being displayed (Step S20), it waits for timing for making a record (Step S21). In this embodiment, as illustrated in FIG. 3, the viewing record is intermittently created at an interval of 10 seconds or the like. If this timing for making the record is not matched, the display device 300 does not do anything but repeats this processing from the beginning again.

When the timing for making the record is matched (Step S21), detection processing of the portable terminal is executed (Step S22). A beacon may be output so as to obtain the identification information of the portable terminal 200 at this point of time, or processing of obtaining the identification information from the portable terminal 200 may be repeatedly executed at a short interval separately from the viewing record storing processing, and a latest detection result may be obtained at Step S22.

The display device 300 updates the viewing record in accordance with the detection result (Step S23).

The viewing record can be created in various formats but can be in a format illustrated in the viewing record database 106 in FIG. 3, for example. At Step S23, time (for example, 13:25:05) and the terminals (for example, 001, 003, and 005) detected at that point of time are associated and recorded.

### D. Video Management Processing:

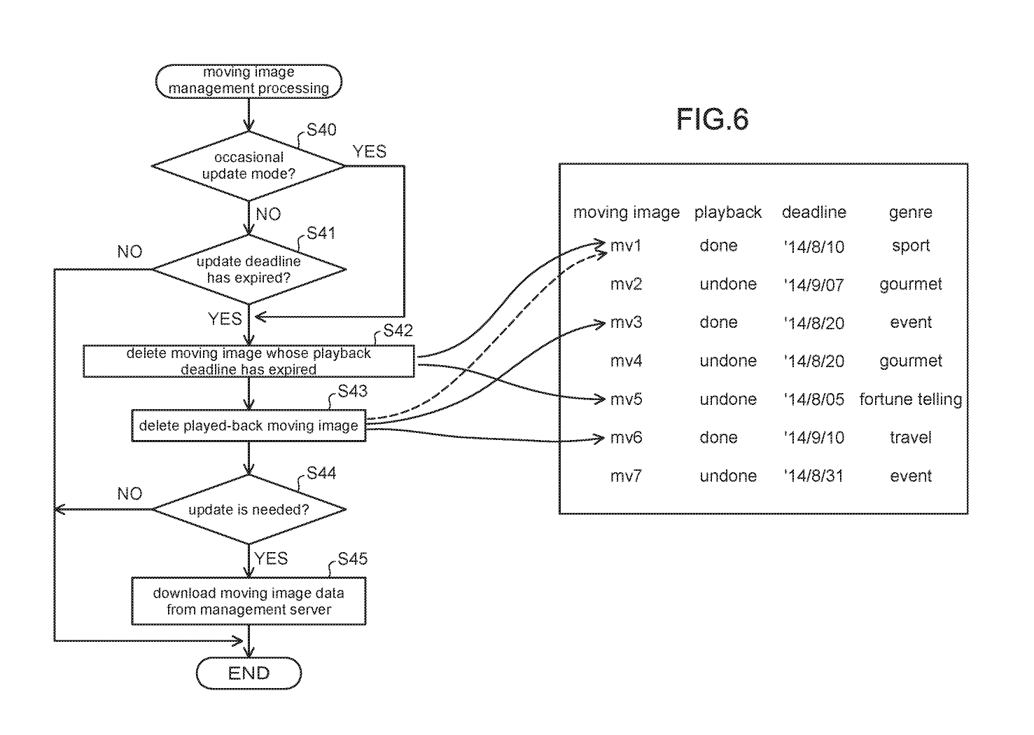

FIG. 6 is a flowchart of video management processing. This is the processing for the display device 300 to download the video data from the management server 100. In this embodiment, it is so configured that the administrator of the display device 300 can make selection from two modes, that is, a mode of periodically updating the video data and a mode of update at any time.

When the display device 300 initiates the video management processing, it determines whether an occasional update mode is selected or not (Step S40). If it is not in the occasional update mode, that is, when the periodic update mode is selected, it is determined whether an update deadline has passed or not (Step S41), and if the update deadline has not passed, the video management processing is finished as it is.

When the occasional update mode is selected (Step S40) or when the update deadline has passed in the periodic update mode (Step S41), the video is updated by the following procedure.

First, the video whose playback period has expired is deleted (Step S42). A state of the processing when the video is updated is illustrated on the right side. It is assumed that the display device 300 stores 7 videos mv1 to mv7. Assuming that a date when the video management processing is executed is Aug. 12, 2014, the playback periods of the videos mv1 and mv5 expire on Aug. 10, 2014 (mv1) and Aug. 5, 2014 (mv5), respectively. Therefore, their playback periods have both expired. Accordingly, at Step S42, the videos of the videos mv1 and mv5 are deleted.

Subsequently, the display device 300 deletes the played-back video (Step S43). In the example on the right side, the videos which have been played back are videos mv1, mv3, and mv6. Since the video mv1 has been already deleted at Step S42, the remaining videos mv3 and mv6 are deleted by the processing at Step S43.

The display device 300 subsequently determines whether update of the video is needed or not (Step S44). If no video has been deleted by the processing at step S42 and S43, for example, it is determined that a need to obtain a new video is low, and the video management processing is finished without updating the video. If the video has been deleted by the processing at Steps S42 and S43, videos as many as the number of the shortage by deletion are downloaded from the management server (Step S45). In the example illustrated on the right side, since four videos have been deleted, four pieces of video data are newly downloaded from the management server 100.

In this example, the case in which seven videos have been stored in the display device 300 is used as an example and explained, but the number of videos that can be stored can be arbitrarily set. Moreover, the maximum number of videos that can be stored do not necessarily have to be maintained. For example, if the video matching the genre or the preference set by the administrator has not been uploaded in the management server 100, even though the four videos are deleted, the number of videos to be downloaded may be kept to 1 to 3. To the contrary, the number of pieces of new video data matching the genre or the preference set by the administrator is checked from the display device 300, and deletion of the videos by the processing at Steps S42 and S43 may be limited to that number as an upper limit.

### E. Viewing Result Tabulation Processing:

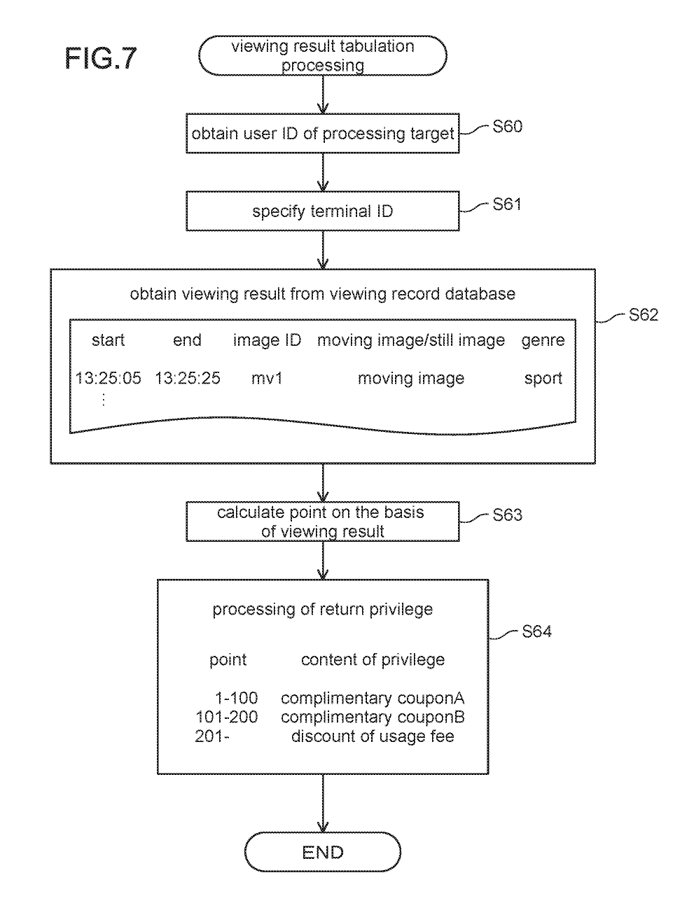

FIG. 7 is a flowchart of viewing result tabulation processing. This is the processing for tabulating viewing records of the viewing record database 106 to determine a privilege to be given to the user in the management server 100.

When this processing is initiated, the management server 100 determines a processing target and obtains its user ID (Step S60). The user ID is information used by the management server 100 for management of the user.

Subsequently, the management server 100 refers to the user database 104 in order to specify a terminal ID, which is identification information of the portable terminal 200 used by the user.

Then, the management server 100 obtains the viewing results from the viewing record database (Step S62). Since the viewing record is created by each of the display device, the record corresponding to the specified terminal ID is extracted from among the viewing record.

In the Figure, the obtainment results of the viewing results are illustrated. For the terminal ID (001) previously shown in FIG. 3, the start time and the end time of viewing can be specified as 13:25:05 and 13:25:25, respectively. In addition, the type of the viewed image can also be specified on the basis of the information about the image ID, video/still image, and the genre in the viewing record.

When the viewing results are tabulated, then, the management server 100 calculates a point on the basis of the viewing results (Step S63). This point is an evaluation value used for handling the viewing results of the images in a unified manner, and the viewing time of the video can be used as that point as it is. Also, the images displayed on the display device 300 include both of the videos and the still images, the point can be calculated by various methods shown below, for example:

Point=point of video×number of viewing times of video+point of still image×number of viewing times of still image; Calculation method 1

Here, arbitrary values can be set to the points of the videos and the still images. For example, considering that the videos are more impressive for users than the still images, the point of the videos may be set higher than that of the still images.

Point=SUM (point of video×viewing time of video×coefficient of video)+SUM (point of still image×display time of still image); Calculation method 2

Here, arbitrary values can be set to the point of video and the point of still image.

The coefficient of the video is a coefficient for adjusting weights of the viewing time of the video and the viewing time of the still image and can be set arbitrarily. Considering that the still images can present much information in relatively short time whilst the video can present useful information only when viewed in a relatively large block of time, the weight per unit time during which the video is viewed is considered to be lighter than the display time of the advertisement and thus, the coefficient of the video is preferably a real number smaller than 1.

SUM indicates that the sum of all the viewing histories of the videos and the still images is obtained.

Calculation of the points can be performed in various methods other than the above. Moreover, if the same video or still image is viewed a plurality of times, the point may be increased or decreased in accordance with the number of viewing times. The videos and the still images may be separately evaluated and points may be calculated for each of them.

The management server 100 executes processing of returning the privilege to the user on the basis of the point obtained as above (Step S64). In this embodiment, in a range of 200 points or less, a complimentary coupon A or a complimentary coupon B is provided to the user in accordance with the point, while in the case of 201 points or more, the usage fee of the portable terminal 200 is discounted. The discount of the usage fee may be a certain amount or a certain rate, or a discount amount or a discount rate may be changed in accordance with the point. Moreover, the user can select whether the user receives the privilege or not. The contents of the privilege may be varied according to the sources such as the videos, the still images, and the voices.

### F. Effects

According to the information provision system in the embodiment described above, the time during which the user was in contact with various types of information displayed by a plurality of the display devices 300 present all around the town can be recorded. Therefore, an administrator of the display device 300 can improve contents of the information to be provided on the basis of the viewing record so as to increase the probability that the users view it. Moreover, since the management server 100 can give a privilege to the user on the basis of the viewing history, it can motivate the user to view the video or advertisement can be also given, whereby efficiency of the information provision can be further improved.

### Embodiment 2

Subsequently, an information provision system as Embodiment 2 will be described.

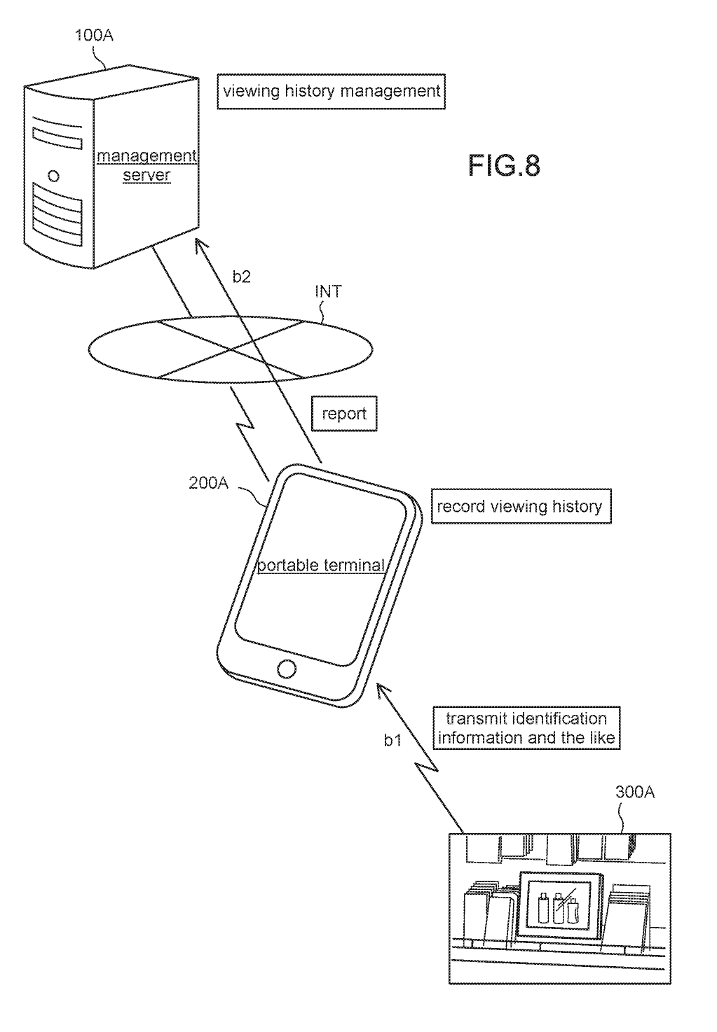

FIG. 8 is an explanatory view illustrating entire configuration of the information provision system in Embodiment 2. On the contrary to Embodiment 1 in which the display device 300 is connected to the management server 100 via the internet INT, Embodiment 2 is an example in which a portable terminal 200A is connected to a management server 100A. Therefore, in Embodiment 2, the portable terminal 200A falls under the first device in the present invention, and the display device 300A falls under the second device.

In the figure, the flow of the information exchanged in the information provision system of Embodiment 2 is illustrated.

When the portable terminal 200A approaches the vicinity of the display device 300A, the short-range communication is established between the both similarly to Embodiment 1. Then, the display device 300A transmits its own identification information to the portable terminal 200A via the short-range communication (arrow b1). The portable terminal 200A can detect the display device 300A by obtaining the identification information. As the identification information, a display device ID specific to the display device 300A can be used, for example.

The display device 300A plays back video data prepared in advance. This video data may be recorded in media such as a DVD or when the display device 300A is connected to the internet INT, it may be delivered from the management server 100A or the like similarly to Embodiment 1.

The display device 300A intermittently transmits the identification information to the portable terminal 200A at predetermined timing while the image is being displayed, and the portable terminal 200A records it as a viewing history. If a plurality of the portable terminals 200A is present in the vicinity of the display device 300A, a viewing history is recorded in each of the portable terminals 200A. In addition, if the portable terminal 200A has obtained the identification information of a plurality of the display devices 300A, the viewing history corresponding to each of the display devices is recorded.

This viewing history is transmitted from the portable terminal 200A to the management server 100A at appropriate timing (arrow b2). The management server 100A manages the viewing history and utilizes it for a privilege such as a discount of a usage fee of the portable terminal 200A.

As described above, Embodiment 1 and Embodiment 2 are different in an entity recording the viewing result of an image and its method. In Embodiment 1, the display device 300 stores the identification information of the portable terminal 200 as a viewing record. This means that, in other words, which users viewed the display device 300 is recorded. On the other hand, in Embodiment 2, the portable terminal 200A stores the identification information of the display device 300A as a viewing history. This means that, in other words, of which the display device 300A information was viewed by the user of the portable terminal 200A is recorded. As described above, in Embodiment 2, since the history viewed by the user is directly recorded, the information recorded in the portable terminal 200A is called a “viewing history”.

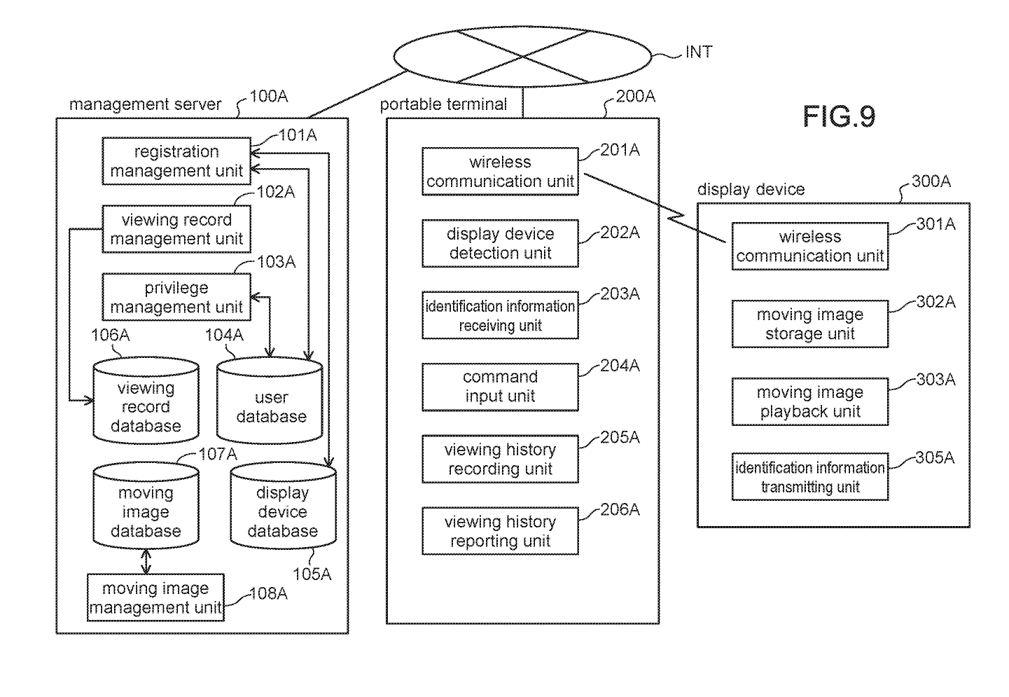

FIG. 9 is an explanatory view illustrating internal configuration of the information provision system in Embodiment 2. The figure shows functional blocks which should be included in each device in order to realize the function described in FIG. 8. Although all the functional blocks are configured in a software manner by installing a computer program for realizing the respective functions mainly in a computer, they may be also configured in a hardware manner.

Configuration of the management server 100A will be described.

The management server 100A includes four databases, that is, a user database 104A, a display device database 105A, a video database 107A, and a viewing record database 106A. The user database 104A, the display device database 105A, and the video database 107A are similar to those in Embodiment 1. The viewing record database 106A is to store the viewing history created by each of the portable terminals 200A. Configuration of the viewing record database 106A can take a format of recording the display device ID instead of the terminal ID in the viewing record database 106 illustrated in FIG. 3, for example. However, since the image ID and the information on video/still image or the like are also different according to each of the display device ID, the viewing record needs to create one record for one display device ID.

Functions of a registration management unit 101A, a viewing record management unit 102A, a privilege management unit 103A, and a video management unit 108A are substantially similar to those in Embodiment 1. However, since the portable terminal 200A records the viewing history in Embodiment 2, an access destination when the management server 100 obtains the viewing history is each of the portable terminals 200A, and processing when the privilege is to be determined also needs processing according to the format of the viewing history.

In Embodiment 2, if the display device 300A is not connected to the internet INT and it is not necessary to deliver the video data from the management server 100A, the video database 107A and the video management unit 108A may be omitted.

Configuration of the display device 300A will be described. To the display device 300A, a display device ID is given as identification information for identifying the display device.

A video playback unit 303A plays back the videos by using the video data stored in a video storage unit 302A. In this embodiment, it is so configured that the videos are played back upon detection that the portable terminal 200A is in the vicinity.

A wireless communication unit 301A exerts a function of establishing the short-range communication with the portable terminal 200A.

An identification information transmitting unit 305A transmits the identification information to the portable terminal 200A via the short-range communication.

Configuration of the portable terminal 200A will be described.

A command input unit 204A inputs a command by an operation by the user via a screen of the portable terminal 200A or various physical switches and the like.

The wireless communication unit 201A exerts a function of establishing the short-range communication with the display device 300A. Since presence of the display device 300A can be detected by establishment of the communication, the wireless communication unit 201A exerts the function as the detecting unit of the first device in the present invention in Embodiment 2.

An identification information receiving unit 203A receives the identification information of the display device 300A via the short-range communication with the display device 300A.

A viewing history recording unit 205A records the identification information from the display device 300A in a time series while the display device 300A is displaying the video. As a result, a viewing record associated with the type and time of the displayed video and the display device displaying it can be created.

A viewing history reporting unit 206A reports the viewing history to the management server 100 at appropriate timing. The timing for reporting and the like can be configured arbitrarily. For example, a method of uploading to the management server 100 periodically, a method of uploading in accordance with a command from the management server 100, a method of uploading when a capacity of the viewing history stored in the portable terminal 200A reaches a predetermined amount or more and the like can be employed.

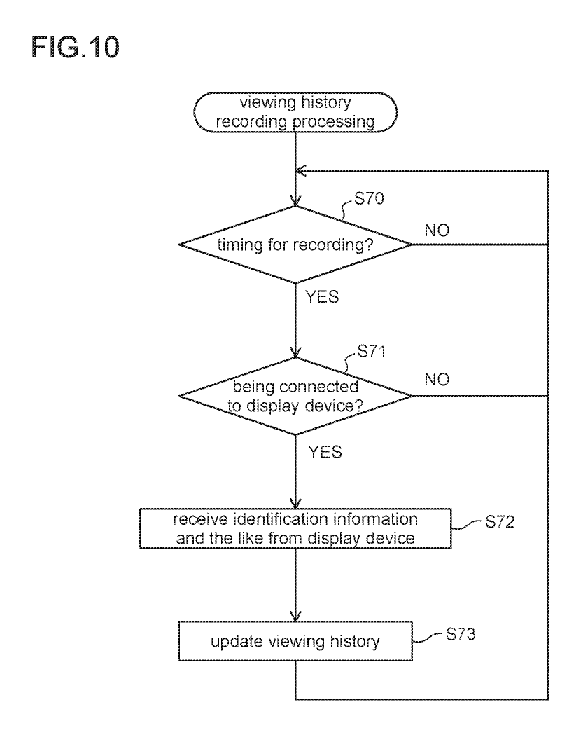

FIG. 10 is a flowchart of viewing history recording processing in Embodiment 2. This is the processing executed by the portable terminal 200.

The portable terminal 200A waits for the timing for recording the viewing history to come when it is not the timing for recording the viewing history (Step S70).

Moreover, even if the timing for recording comes (Step S70), when the portable terminal 200A is not connected to the display device 300A (Step S71), it does not record the viewing history and repeats the processing from the beginning.

When the portable terminal 200A is connected to the display device 300A (Step S71), it receives the identification information and the like from the display device (Step S72) and updates the viewing history (Step S73). Information received from the display device can includes the display device ID, the image ID which is the identification information of the image being played back by the display device, the type of the video/still image, the genre of the image and the like.

By repeating the processing above, the portable terminal 200A can create the viewing history in a format obtained by substituting the terminal ID by the display device ID in the viewing record database 106 (see FIG. 3) in Embodiment 1.

Viewing result tabulation processing for the management server 100 to give back a privilege to the user (see FIG. 7) is similar to Embodiment 1.

By means of Embodiment 2 described above, the viewing history of the videos played back by the display device 300A can also be created, and it can be utilized for improving display contents, motivating the users to view the display, and the like.

The present invention does not necessarily have to include all the various features in the aforementioned Embodiment 1 and Embodiment 2, and various variations can be constituted by omitting or combining a part thereof as appropriate.

The present invention can be used for managing a viewing result of advertisement and other types of information provided via the output device installed in advance.

What is claimed is:

1. An information provision system comprising:
a portable terminal used by a user;
an output device configured to output information; and
a management server connected to the portable terminal or the output device via a network, one of the output device and the portable terminal which is connected to the management server being referred to as a first device and the other being referred to as a second device,
wherein the first device includes:
a detection unit configured to detect, within a time period during which the information is output from the output device, that the second device is in a predetermined positional relationship with respect to the first device in which a user of the second device is capable of being in contact with the information;
an identification information obtaining unit configured to obtain identification information specific to the second device from the detected second device; and
a contact record storing unit configured to store a result of the detection by the detection unit and the obtained identification information as a contact record of the information with which the user of the second device was in contact, and
wherein the management server comprises:
a contact record database configured to store the contact record; and
a contact record management unit configured to obtain the contact record from the first device via the network and storing the contact record in the contact record database.

2. The information provision system according to claim 1, wherein
each of the output device and the portable terminal comprises a communication device capable of communicating information to each other, and
the identification information obtaining unit obtains the identification information via the communication device.

3. The information provision system according to claim 1, wherein
the detecting unit intermittently performs a detection within the time period during which the information is output from the output device.

4. The information provision system according to claim 1, wherein
the output device starts outputting the information triggered by detection of the portable terminal or by being detected by the portable terminal.

5. The information provision system according to claim 1, wherein the output device is connected to the network, the output device comprising:
an information obtaining unit configured to obtain information data for outputting the information via the network; and
an information recording unit configured to record the obtained information data, wherein the information obtaining unit obtains the information data when at least one of the following conditions is satisfied:
there is no more information data which has not been output in the information storage unit; and
there is no more information data having an unexpired viewing period in the information storage unit.

6. The information provision system according to claim 1, wherein the contact record management unit comprises:
a privilege management unit configured to determine a privilege given to the user of the portable terminal.

7. The information provision system according to claim 6, wherein
at least one of the first device and the management server compensates missing of the detection within a predetermined time period in the detection results in order to specify a time period during which the user is in contact with the information and to determine the privilege.

8. An output device connected to the management server in an information provision system via a network, the output device being configured to output the information and comprising:
a detecting unit configured to detect, within a time period during which the information is output, that the portable terminal used by a user of the information provision system is in a predetermined positional relationship with respect to the output device;
an identification information obtaining unit configured to obtain identification information specific to the portable terminal from the detected portable terminal;
a contact record storing unit configured to store a result of the detection by the detection unit and the obtained identification information as a contact record of the information with which the user of the portable terminal was in contact; and
a contact record reporting unit configured to report the contact record to the management server.

9. A method for managing a contact record that a user was in contact with information in an information provision system including a portable terminal, an output device, and a management server connected to the portable terminal or the output device via a network, one of the output device and the portable terminal which is connected to the management server being referred to as a first device and the other being referred to a second device, the method comprising:
detecting by the first device, within a time period during which the information is output from the output device, that the second device is in a predetermined positional relationship with respect to the first device in which a user of the second device is capable of being in contact with the information;
obtaining, by the first device, identification information specific to the second device from the detected second device; and
storing, in the first device, a result of the detecting and a result of the obtaining the identification information as a contact record of the information with which the user of the second device was in contact, and
obtaining, by the management server, the contact record from the first device via the network, and storing the contact record in a contact record database in the management server.
